(19) United States
(12) Patent Application Publication
(10) Pub. No.: US 2004/0054579 A1
(43) Pub. Date: Mar. 18, 2004

(54) Method and apparatus for establishing and operating credit promotions

(76) Inventors: Tom Lamb, Mooresville, NC (US); Mark Malone, North Wilkesboro, NC (US); Bart Schaller, Dallas, TX (US); Tara Strauss, Mountain Lakes, NJ (US); Clarence Harris, Chicago, IL (US); Allan Schwedock, Norwalk, CT (US); Carlos Nino, Charlotte, NC (US); Kathleen Maher, Charlotte, NC (US)

Correspondence Address: BUCKLEY, MASCHOFF, TALWALKAR LLC, 5 ELM STREET, NEW CANAAN, CT, 06840, US

(21) Appl. No.: 10/394,440

(22) Filed: Mar. 21, 2003

Related U.S. Application Data
(60) Provisional application No. 60/366,313, filed on Mar. 21, 2002.

(51) Int. Cl. G06F 17/60

(52) U.S. Cl. 705/14

(57) ABSTRACT

A system, method, apparatus, and computer program products for operating a credit promotion program includes identifying a consumer who wishes to participate in the promotion, identifying a voucher associated with the credit promotion program, and identifying a purchase by the consumer, including a purchase amount and a purchase date. A credit promotion period for the consumer is then opened if the purchase amount exceeds a pre-established trigger amount. The consumer's purchases during the promotion period are then monitored for subsequent application of promotion benefits.

### CROSS-REFERENCE TO RELATED APPLICATIONS

This application hereby claims the benefit of U.S. Provisional Patent Application No. 60/366,313 entitled “METHOD AND APPARATUS FOR ESTABLISHING AND OPERATING CREDIT PROMOTIONS” and filed Mar. 21, 2002, the contents of that application are incorporated herein by reference for all purposes.

### BACKGROUND OF THE INVENTION

1) Field of the Invention

The present invention relates to credit systems. In particular, embodiments of the present invention relate to methods, apparatus, systems, and computer program products for establishing and operating credit promotions.

2) Description of Related Art

Credit promotions are quite popular with merchants, consumers and financial institutions. One existing promotion provides consumers with the opportunity to make a number of purchases using a credit account, and then receive a period in which the interest charges typically applied to the account are waived. Some promotions also allow the consumer to skip one or more payments that would otherwise be required to keep the account current. This type of program is sometimes referred to as an “after the fact free” (“AFF”) program. Other promotions require a minimum monthly payment to qualify for a waiver of finance charges during a promotion period. Still other promotions require the total amount charged to be paid in full before the end of the promotion period to qualify for a waiver of interest charges.

Unfortunately, these existing promotions typically involve the establishment of a fixed “window” for the promotion period. All consumers who wish to take advantage of the promotion must make qualifying purchases at participating merchants within this established window. Consumers are not allowed to pick the start time for the window. Existing promotions also suffer in that they require each purchase made by a consumer during the promotion window to be greater than a pre-established minimum amount. These restrictions relating to existing promotional programs reduces the consumer incentive value of the promotions, as many consumers are not financially able to make multiple purchases satisfying the established minimum amount.

Thus, there remains a need for improved methods, apparatus, systems, and computer program products for establishing and operating credit promotions that will provide the merchant and consumer with a promotional program having flexible terms, including, but not limited to, flexibility in the start date, length of the promotional period, and the required minimum purchase price. In addition, the improved methods, apparatus, systems, and computer program products should also increase the consumer incentive value of the promotional program for the merchant.

### SUMMARY OF THE INVENTION

Embodiments of the present invention provide systems, methods, apparatus, and computer program products for establishing and operating credit promotions.

According to one embodiment of the present invention, a system, method, apparatus, and computer program product for operating a credit promotion program includes identifying a consumer who wishes to participate in the promotion, identifying a voucher associated with the credit promotion program, and identifying a purchase by the consumer, including a purchase amount and a purchase date. A credit promotion period for the consumer is then opened or begun if the purchase amount exceeds a pre-established trigger amount. The consumer's purchases during the promotion period are then monitored for subsequent application of promotion benefits.

According to one embodiment, the credit promotion period ends a predetermined time from the purchase date. At the end of the period, a total amount of qualifying purchases are identified and the consumer is provided a predetermined credit benefit or a variable credit benefit based on the total amount. The result is a system, method, apparatus and computer program product which allows individual consumers the flexibility of choosing when and where to start their individual promotion. Further, in some embodiments, the consumer realizes benefits on all purchases made during the promotion period, eliminating the requirement that all purchases exceed a certain amount. As a result, the consumer is motivated to make multiple purchases at the corresponding merchant or merchants during the promotional period.

According to another embodiment of the present invention, a system, method, apparatus, and computer program product for establishing a credit promotion program is provided which includes establishing terms of the credit promotion program, including at least a trigger event and at least one promotional period duration. Target consumers are identified and a plurality of vouchers for initiating the credit promotion program are generated and are made available to customers through one or more channels, including, but not limited to, forwarding to the target consumers (e.g., via direct mail), distributing to the target customers through media advisements, or making available in-store. The system then monitors for occurrence of the trigger event for each the target consumers and/or presentation of a voucher by the target consumers.

Accordingly, there are provided improved methods, apparatus, systems, and computer program products for establishing and operating credit promotions that will provide the merchant and consumer with a promotional program having flexible terms, including, but not limited to, flexibility in the start date, length of the promotional period, and the required minimum purchase price. In addition, the improved methods, apparatus, systems, and computer program products will also increase the consumer incentive value of the promotional program for the merchant so that consumers will make multiple purchases during the promotional period.

### BRIEF DESCRIPTION OF THE DRAWINGS

The foregoing and other advantages and features of the invention, and the manner in which the same are accomplished, will become more readily apparent upon consideration of the following detail description of the invention taken in conjunction with the accompanying drawings, which illustrate preferred and exemplary embodiments and which are not necessarily drawn to scale, wherein:

FIG. 1 is a block diagram illustrating a system, according to one embodiment of the present invention;

FIG. 2 is a block diagram illustrating one embodiment of the promotion processor depicted in FIG. 1;

FIG. 3 is a flow diagram illustrating an exemplary process for establishing a credit promotion pursuant to one embodiment of the present invention;

FIG. 4 is a flow diagram illustrating an exemplary process for operating a credit promotion pursuant to one embodiment of the present invention;

FIG. 5 is a tabular representation of a portion of a promotion database, according to one embodiment of the present invention; and

FIG. 6 is a tabular representation of a portion of a transaction database, according to one embodiment of the present invention.

### DETAILED DESCRIPTION

Applicants have recognized that there is a need for methods, systems, apparatus, and computer program products for establishing and operating credit promotions which overcome drawbacks of existing promotion programs. According to one embodiment of the present invention, a credit promotion may be established which allows customers to select the start date of the promotion by executing a qualifying purchase (or “trigger purchase”) at a sponsoring merchant location and/or by presentation of a voucher at a sponsoring merchant location. Once a customer has started the promotion by executing a trigger purchase or presenting a voucher, the promotion will run for a predetermined duration, during which the customer may make any number of purchases of any amount at a sponsoring merchant. All purchases made by the customer using a credit account during this promotion period are eligible for promotion benefits. The promotion benefits may include enjoyment of a period of no payments on the credit account and/or a period of no interest charges. The benefit period can be predetermined or based upon the amount of purchases made by the consumer at a sponsoring merchant.

It is believed that promotions conducted using embodiments of the present invention will be useful in attracting and rewarding customers who are in the process of undertaking or experiencing projects which require frequent purchases and will motivate the purchasers to make multiple purchases during the promotion period. For example, consumers who are moving or undertaking a remodeling project make many purchases over a period of time. These consumers benefit from flexible promotions offered and operated using embodiments of the present invention.

A number of terms will be used herein to describe features of the present invention. For example, the term “consumer” will be used to refer to individuals or entities which are offered the choice of participating in promotions operated pursuant to embodiments of the present invention. The term “merchant” will be used to refer to the entity that offers consumers the ability to purchase goods or services in the promotion. A merchant may be a retailer, a wholesaler, or other entity offering goods or services to consumers.

AFF promotions described herein are generally associated with promotions which provide extended credit benefits to consumers for certain purchases made at participating merchants. As used herein, the credit benefits are generally described in relation to purchases made using credit accounts accessed using “credit cards” or “payment cards”. As used herein, the term “credit card” is used to refer to cards issued by financial institutions or other entities to consumers to access credit or debit accounts established on behalf of the consumer. As used herein, the term “credit card” generally includes different types of payment cards, such as co-brand cards, private label cards, and other card products which provide access to consumer accounts for which AFF promotions provide consumer incentives. For convenience, the term “credit card”, as used herein, will generally be used to refer to both the physical card (which may be a magnetic stripe, smart card, or other type of card), as well as the account associated with the card.

These and other features will be discussed in further detail below, by first describing a system, individual devices, exemplary databases and processes according to embodiments of the invention.

System

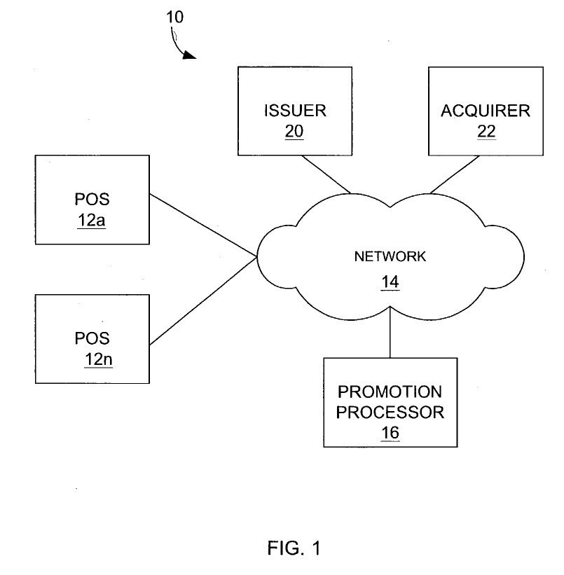

Referring now to FIG. 1, a system 10 for establishing and operating credit promotions pursuant to embodiments of the invention is shown. In the embodiment depicted in FIG. 1, a number of point of sale (POS) devices are shown in communication with a promotion processor 16, an issuer 20, and an acquirer 22 via a communication network 14.

POS devices 12a-n, promotion processor 16, issuer 20, and acquirer 22 may be any devices capable of performing the various functions described herein. For example, POS devices 12a-n may be any of a number of known point of sale, point of purchase, or point of transaction devices which are used to process sales or purchases of goods. For example, one or more of POS devices 12a-n may be a VeriFone® Omni 3350 point of sale terminal or similar device which is configured to read payment card information at a point of sale. In some embodiments, POS devices 12a-n may be coupled to a store server which is in communication with network 14. In other embodiments, POS devices 12a-n are in direct communication with other devices of system 10 via network 14. Any number of POS devices 12a-n may be used in conjunction with embodiments of the present invention.

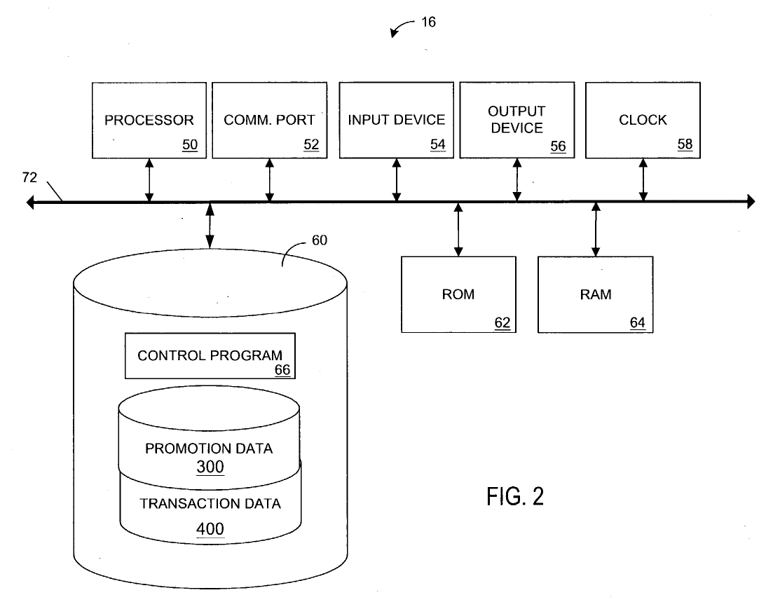

Promotion processor 16 (one embodiment of which will be described further below in conjunction with FIG. 2) may be operated by or on behalf of a merchant or other entity offering promotions pursuant to embodiments of the present invention. In some embodiments, promotion processor 16 may be operated by a merchant acquirer or other entity that processes payment card transaction data. In other embodiments, promotion processor 16 may be operated by the merchant. In yet other embodiments, promotion processor 16 may be operated by a financial institution such as issuer 20 or acquirer 22. Promotion processor 16 may be a stand-alone computer configured to manage promotions pursuant to embodiments of the invention, or the functionality of promotion processor 16 may be included in existing devices configured to process transaction data (e.g., as a part of a merchant acquirer processing system).

Issuer 20 is a financial institution or other entity that issues credit cards used in promotions pursuant to embodiments of the present invention. Acquirer 22 is a financial institution or other entity that receives and processes transaction data from a merchant participating in promotions pursuant to embodiments of the present invention. Issuer 20 and acquirer 22 may be the same entity. Similarly, the issuer 20, acquirer 22, and merchant may be the same entity. The processing and interaction in payment card transactions between these entities is well-known in the art and need not be discussed further herein.

As used herein, network 14 may employ any of a number of different types and modes of communication, and may be for example, a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Network 14 may also be, for example, a financial transaction network, such as the VisaNet® network or other similar networks configured to route and transmit payment information. A variety of individual networks and network protocols may be used in combination to transmit information between devices. Moreover, as used herein, communications include those enabled by wired or wireless technology.

As will be described further below, system 10 is operated to allow individual consumers to participate in promotional programs which allow the consumer the flexibility to choose the start date of the promotional program. Further, promotional programs operated pursuant to embodiments of the present invention permit consumers to enjoy the benefits of a period of no payments and/or no finance charges for a number of different purchases made during a promotional period, with only an initial purchase that is required to be above a trigger amount and/or with only the presentation of a voucher to the sponsoring merchant. The result is increased flexibility, choice, and savings for consumers. Merchants benefit through an ability to attract new customers and the generation of increased sales through repeat purchases by the target consumers during the promotional period. Financial institutions benefit from increased card usage and new account acquisitions.

Further details of one embodiment of promotion processor 16 will now be described by referring to FIG. 2. In one embodiment, promotion processor 16 is operated by a merchant processor which has a relationship with a merchant desiring to offer promotions pursuant to embodiments of the present invention. Those skilled in the art will recognize, upon reading this disclosure, that promotion processor 16 may be implemented as a system controller, a dedicated hardware circuit, an appropriately programmed general purpose computer, or any other equivalent electronic, mechanical or electro-mechanical device capable of providing the functionality described herein.

FIG. 2 is a block diagram of the internal architecture of promotion processor 16, according to one embodiment of the invention. As illustrated, promotion processor 16 includes a microprocessor 50 in communication with communication bus 72. Microprocessor 50 may be a Pentium™ or other type of processor and is used to execute processor-executable process steps to control the components of promotion processor 16 to provide functionality according to embodiments of the present invention.

A communication port 52 is also in communication with communication bus 72. Communication port 52 is used to transmit data to and to receive data from devices external to promotion processor 16. Communication port 16 is therefore preferably configured with hardware suitable to physically interface with desired external devices and/or network connections. In one embodiment, files of electronic information are transmitted to and received from POS devices 12a-n and other devices via communication port 52.

An input device 54 and an output device 56 are also in communication with communication bus 72. Any known input device may be used as input device 54, including a keyboard, mouse, touch pad, voice-recognition system, or any combination of these devices. Input device 54 may be used by an entity to input promotional information or parameters and other data to promotion processor 16. Such information may also be input to promotion processor 16 via communication port 52. Commands for controlling operation of promotion processor 52 may also be input using input device 54, such as commands to transmit a file, to receive a file, or the like.

Output device 56 may be any of a number of known output devices, such as, for example, a display device, a printer, or the like. A variety of memory devices may also be coupled to communication bus 72, including a random-access memory (RAM) 64 to provide microprocessor 50 with fast data storage and retrieval. In this regard, processor-executable process steps being executed by microprocessor 50 are typically stored temporarily in RAM 64 and executed therefrom by microprocessor 50. A read-only memory (ROM) 62, in contrast, provides storage from which data can be retrieved but to which data cannot be stored. Accordingly, ROM 62 may be used to store invariant process steps and other data, such as basic input/output instructions and data used during system boot-up or to control communication port 52. One or both of RAM 64 and ROM 62 may communicate directly with microprocessor 50 instead of over communication bus 72.

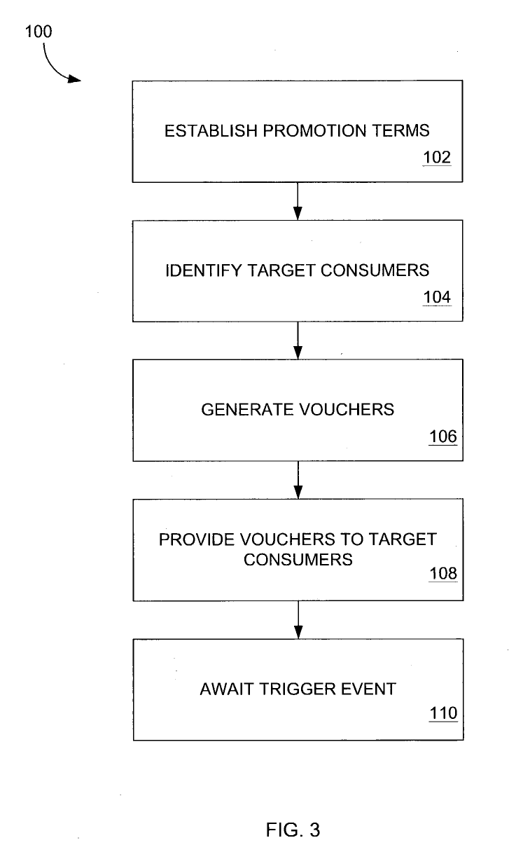

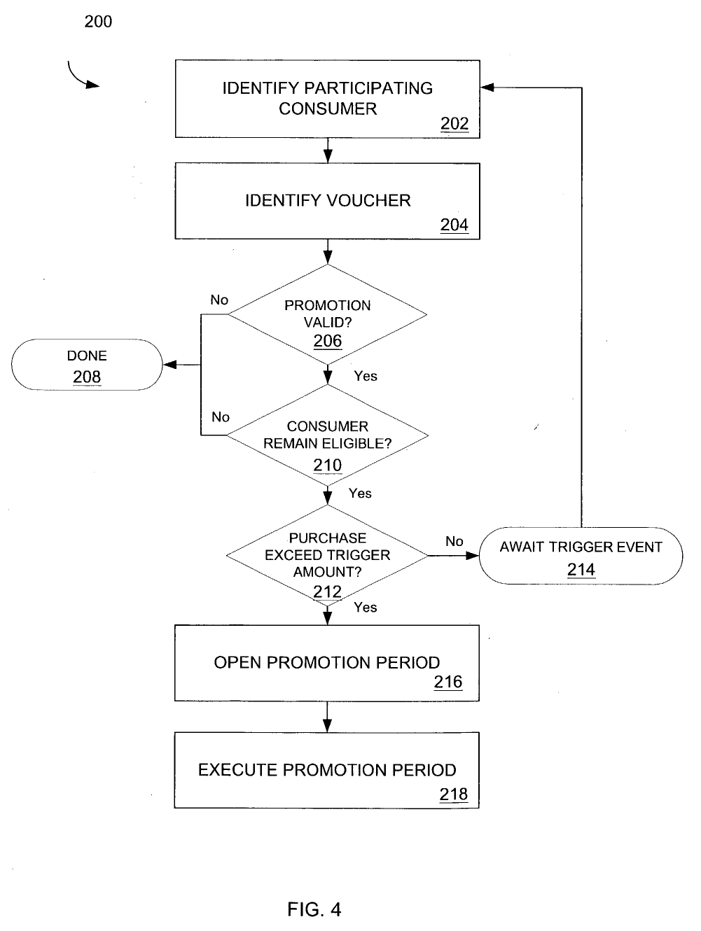

A data storage device 60 stores, among other data, a control program 66 of processor-executable process steps. Microprocessor 50 executes process steps of control program 66 to control promotional processor 16 to operate and manage promotional programs pursuant to embodiments of the present invention. More specifically, the process steps of control program 66 may be executed by microprocessor 50 to achieve the functionality described in conjunction with FIGS. 3 and 4, below. Microprocessor 50 and data storage device 60 may each be, for example: (i) located entirely within a single computer or other computing device; or (ii) connected to each other by a remote communication medium, such as a serial port cable, telephone line or radio frequency transceiver. In one embodiment, promotional processor 16 may comprise one or more computers that are connected to a remote server computer for maintaining databases.

The process steps of control program 66 may be read from a computer-readable medium (e.g., a floppy disk, a CD-ROM, a magnetic tape, a signal encoding the process steps, or the like) and then stored in data storage device 60 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

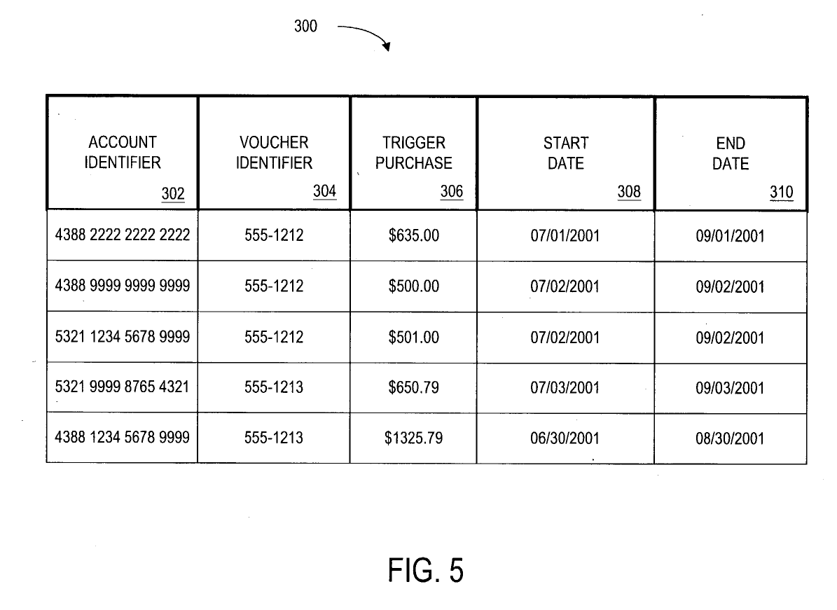

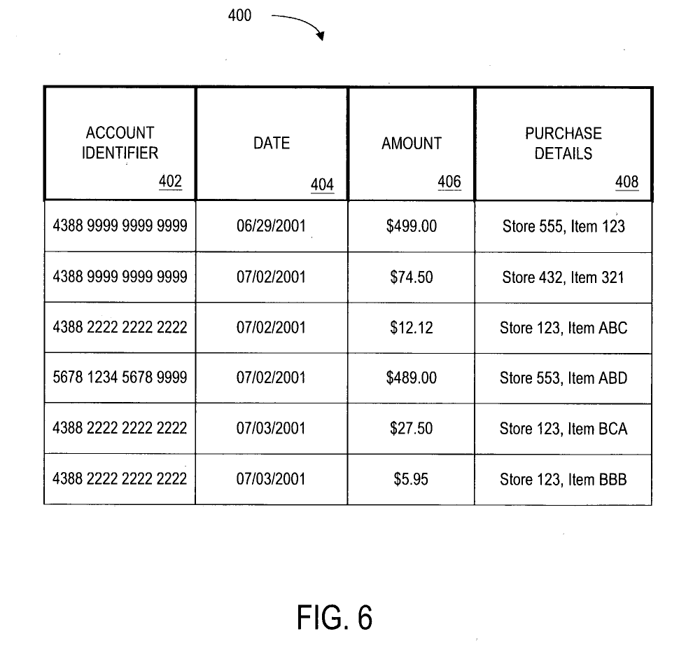

Data storage device 60, in one embodiment, also stores a promotion database 300 and a transaction database 400. These databases are described in detail below in conjunction with FIGS. 5 and 6. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

Process Description

Reference is now made to FIG. 3, where a flow chart is shown which represents an exemplary process 100 for establishing a credit promotion pursuant to embodiments of the present invention. The particular arrangement of elements in the flow chart of FIG. 3 is not meant to imply a fixed order to the steps; embodiments of the present invention can be practiced in any order that is practicable. In one embodiment, some or all of the steps of process 100 are performed under the direction or control of promotion processor 16. In other embodiments, some or all of the steps may be performed by other devices or groups of devices of system 10. In one embodiment, process 100 is performed prior to the beginning of the promotion pursuant to embodiments of the present invention. For example, process 100 may be performed once a merchant has determined that it wishes to conduct a promotion.

Process 100 begins at 102 where promotion terms are established. Promotion terms established at 102 may include terms such as: the duration of the promotion; the duration of the promotion benefit period, e.g., the duration of the no payment period and/or period of no interest charges; trigger amounts required to initiate the promotion for individual cardholders; etc. In one embodiment, the duration of the promotion benefit period is dependent upon the amount of purchases made by the target consumer during the promotion period, wherein the greater the amount of purchases by the target consumer, the longer the promotion benefit period will be. Promotion terms may be pre-established for a variety of different types of promotions. A merchant wishing to offer one of the promotions may then simply select from among the existing programs and existing terms.

Processing continues at 104 where one or more target consumers are identified. For example, a merchant may determine that it wishes to target a particular type of consumer for participation in the program. In one embodiment, the merchant is a home improvement store desiring to target existing and potential customers who may be initiating home improvement projects that may result in a number of purchases over a period of time. Consumers who are in the process of moving may also be identified as target consumers, because a move typically requires multiple purchases over a period of time. In another embodiment, the merchant is an electronics store desiring to target existing and potential customers who may be initiating the purchase of a computer or home stereo system. These target consumers may be identified in any of a number of different ways known in the art. Some of these target consumers may already be credit card holders. Other target consumers may be identified because they do not currently have a credit card (or because they do not currently have a credit card associated with the merchant, such as the merchant's private label card).

In some embodiments (where the promotion involves the use of vouchers presented by consumers at the point of sale), processing continues at 106 where vouchers are generated. Vouchers generated at 106 may be coupons, free standing inserts, advertisements, fliers, direct mailings, adhesive labels applied to one or more products offered by the merchant, electronic mailings, Web sites, or other materials which include a voucher identifier or other number or code printed or otherwise encoded on it so that it can be registered. For example, the voucher identifier, number or code can be magnetically or optically registered. In one currently-preferred embodiment, the voucher identifier is encoded on the voucher as a bar code or other machine-readable code. In other embodiments, the voucher identifier may be presented in human-readable form. In still other embodiments, the voucher identifier may simply be replaced by a hardwired or preset key (or keys) on a POS device which may be selected by a salesperson when a consumer indicates that she wishes to participate in a particular promotion. In still another embodiment, one or more consumers may receive electronic vouchers via the Internet (e.g., in the form of an electronic mail message or a link to a Web page which includes voucher information on it). According to one embodiment of the present invention, processing at 106 may also include the generation of a promotion database such as the database 300 described below in conjunction with FIG. 5. This database may then be used to track each voucher and each consumer's initiation of a promotion.

In some embodiments, where vouchers are generated at 106, processing continues at 108 where the generated vouchers are provided to target consumers. Vouchers may be provided in any of a number of different ways, including, for example, direct or mass mailings, electronic mailings, Web pages, in-store promotions, etc. Promotional materials explaining the promotion terms established at 102 may also be provided with the vouchers. Consumers receiving the vouchers are encouraged to use the voucher along with a credit card to make a trigger purchase at the merchant. In some embodiments, the consumer may be encouraged to open a new credit account (e.g., apply for a private label or store-card account) in order to qualify for the promotion. In other embodiments, consumers with existing credit accounts may be encouraged to utilize their existing accounts. In some embodiments, where vouchers are not used, processing may include notifying target consumers of the terms of a promotion (e.g., by providing promotional materials to the targeted consumers).

Processing continues at 110 where the system awaits trigger events. According to one embodiment of the invention, unlike previous systems, promotions may be conducted which allow individual consumers to select the time at which a promotion starts. A consumer may thus wait until a major purchase event occurs (e.g., where the merchant is a home improvement store, targeted consumers may wish to wait until the consumer moves to a new home, or when the consumer begins a home improvement project, etc.). In some embodiments, the trigger event may be the presentation of a voucher at a point of sale. In some embodiments, the trigger event may be the use of a qualifying credit card at the merchant to make a purchase of a qualifying amount or greater. The result is a promotion system and method which provides great convenience and flexibility to individual consumers and merchants, allowing individual consumers the flexibility and control of starting a promotion period, and providing merchants with a promotional program with an enhanced incentive value for consumers to make multiple purchases during the promotion period.

Referring now to FIG. 4, a flow chart is shown which describes an exemplary process 200 for operating a credit promotion pursuant to embodiments of the present invention. Process 200 may be performed under the control of promotion processor 16. In some embodiments, some or all of the steps of process 200 are performed by other devices or entities of system 10.

Processing begins at 202 where a participating consumer is identified. A participating consumer may be identified based on an application for participation in the promotion (e.g., via an application for a new credit account in order to enjoy the benefits of the promotion); by presentation of a voucher issued to, or obtained by, the consumer (e.g., as described in FIG. 3 above); or simply by presentation of a qualifying credit card to make a qualifying purchase. In one embodiment, as illustrated in FIG. 1, this identification is performed at POS 12 by presenting a credit card and a voucher to a cashier or attendant operating POS 12. In another embodiment, the consumer may present a voucher or voucher identifier via the Internet.

Processing continues at 204 where the voucher presented is identified. This may be performed, in one embodiment, by scanning or registering information printed on the voucher to retrieve a voucher identifier and comparing a voucher identifier with a plurality of stored voucher identifiers. In another embodiment, the voucher may be identified over the Internet by the customer accessing a Web site or responding to an electronic mail message. In some embodiment, processing at 204 may simply include the cashier or attendant identifying the transaction as involving a particular promotion (e.g., by depressing a specially-coded key associated with a POS device). This voucher identifier may be information identifying a particular promotion in which the consumer wishes to participate.

Processing continues at 206 where a determination is made whether the promotion is a valid promotion. For example, the validity of individual promotions may be determined by determining whether the voucher identifier read from the voucher at 204 is valid. Processing at 206 may involve searching or checking a database or other source of information to determine if the particular promotion is still in existence. If not, processing continues at 208 and the consumer is not enrolled in the promotion.

Processing continues at 210 if the promotion is a valid promotion, where a determination is made whether the consumer is eligible for participation in the promotion. This determination may involve any of a number of criteria, such as, for example, requiring that the consumer present a valid credit card, requiring that the consumer present a particular type of credit card (e.g., issued by a particular financial institution, co-branded by a particular merchant, etc.). Processing at 210 may also include determining whether the consumer is already participating in the promotion (or has already participated in the promotion), in which case the consumer may not be eligible to restart another promotion (e.g., in some embodiments, only a single promotion window may be open for each consumer at a time; in some embodiments a merchant may limit the number of promotions each account may participate in).

Processing continues at 212 where a determination is made whether the consumer is making a purchase that exceeds a pre-established trigger amount. In one embodiment, consumers may be required to make an initial trigger purchase to initiate a promotional period for that consumer. According to the embodiment illustrated in FIG. 1, the determination step can include the promotion processor 16 comparing the purchase amount inputted by the POS attendant on the POS 12 to a predetermined trigger amount stored on the data storage device 60 or at another devices of system 10. If processing at 212 indicates that the consumer did not make a sufficiently large purchase, the consumer is so notified and the promotion period does not commence. The consumer may be notified by the POS attendant, on a receipt, etc. If processing indicates that the consumer did not make a sufficiently large purchase, processing continues to 214 where the consumer is notified that the promotion is still valid, but that a larger purchase must be made to trigger the promotion period. The consumer may be notified of this by the POS attendant, on a transaction receipt, or by other means.

If the purchase was sufficiently large, processing continues at 216 where the promotion period is opened for the consumer. This may involve, for example, writing a start date in promotion database 300 (as described below in conjunction with FIG. 5). An end date may also be indicated in promotion database 300. The start and the end dates stored in promotion database 300 define a promotion period for the consumer. Processing continues to 218 where the promotion period is executed. Execution may involve tracking purchases made by the consumer during the promotion period and then applying a promotion benefit to the account at the end of the promotion period (e.g., a no-fee and/or no-interest benefit may be applied to the account at the end of the period). Purchases may be tracked by reference to a transaction database, such as the database 400 shown and described below in conjunction with FIG. 6. In some embodiments, information regarding the status of the promotion may be printed and presented to the consumer monthly on the consumer's credit card account statement. For example, in some embodiments, the consumer's credit card account statement may indicate: information identifying the consumer's promotion period start and end dates; information identifying qualifying transactions; and information identifying promotion benefits accrued during the period (if any).

Databases

Referring to FIG. 5, a table represents promotion database 300 that may be stored at promotion processor 16 according to an embodiment of the present invention. In some embodiments, all or portions of promotion database 300 may be stored at other devices of system 10 (e.g., at POS devices 12, at a POS controller (not shown) coupled to POS devices 12, at acquirer 22, at issuer 20, etc.)

The table includes entries identifying individual promotional offers that may be associated with individual customers. The table also defines fields 302-310 for each of the entries. In one embodiment, the fields specify: an account identifier 302, a voucher identifier 304, a trigger purchase 306, a start date 308, and an end date 310. The information in promotion database 300 may be created and updated, for example, by an entity operating a promotion pursuant to embodiments of the present invention (e.g., such as a merchant, a financial institution, a third-party processor, etc.).

Account identifier 302 includes information identifying a particular credit card account associated with a consumer who has performed steps necessary to trigger a promotion pursuant to embodiments of the present invention. Account identifier 302 may be information read from a magnetic stripe or other storage device of a credit card. This information is well known in the art and is commonly used to associate a cardholder and the cardholder's account with a particular transaction. In one embodiment, this information is stored in database 300 only if the cardholder is eligible for participation in the promotion (e.g., as described in conjunction with FIG. 4, above).

Voucher identifier 304 may be, for example, an alphanumeric code that has been established to identify a particular promotional program. For example, a merchant (or a merchant processor operating promotions for merchants) may establish several different promotions having different trigger levels, different benefits, and different terms. By providing vouchers having voucher identifiers, these different promotions may be distinguished and tracked. In one embodiment, voucher identifier is read or registered (e.g., optically or magnetically using a bar code reader, a scanner, a magnetic stripe reader, or some other means, or visually by the POS attendant) from the face of a voucher that has been provided to, or selected by, the consumer associated with the credit account identified by account identifier 302. In other embodiments, each consumer may be associated with a specific voucher identifier allowing system 10 to provide specific benefits to specific consumers.

Trigger purchase 306 includes information identifying the particular purchase that triggered the start of the promotion pursuant to the present invention. In some embodiments, the trigger amount is the same for all participants in the program (e.g., an initial trigger purchase in excess of $500.00 may be required to initiate the promotion for each cardholder). In other embodiments, the trigger amount may be varied among different cardholders (e.g., one cardholder may have a trigger purchase requirement of $100.00 while another may have a requirement of $500.00). Trigger purchase 306 may include other information identifying the purchase as well, including, for example, information identifying the particular store in which the purchase was made, information identifying the particular item(s) purchased, etc.

Start date 308 includes information identifying the date of trigger purchase 306. In one embodiment, the promotion period for the consumer associated with the account identified by account identifier 302 begins on the date of trigger purchase 306. This information may be stored in database 300 at start date 308. In one embodiment, promotion processor 16 performs a daily, weekly, or other periodic check on information in promotion database 300 to determine which accounts made qualifying trigger purchases within the period. Those qualifying accounts may be identified and fields of database 300 populated with the current date as the date of the start of the promotion period for those accounts.

End date 310 includes information identifying the date on which the promotion period will terminate for the consumer associated with the account identified by account identifier 302. In one embodiment, end date 310 is automatically calculated based on program rules established prior to initiation of the promotion. For example, the program rules may indicate that the promotion period will be a 60 day period from the start date 308. This information is used, for example, to determine which purchases by the consumer will be entitled to the promotional offer. In one embodiment, the end date 310 may be populated in database 300 when the periodic review described in conjunction with start date 308 is performed (e.g., all qualifying accounts identified during a period may be given the same start and end dates).

Those skilled in the art will recognize that other information may also be included in promotion database 300, including information further identifying the promotion and information further identifying each cardholder.

Referring now to FIG. 6, a table represents transaction database 400 that may be stored at promotion processor 16 according to an embodiment of the present invention. In some embodiments, all or portions of transaction database 400 may be stored at other devices of system 10 (e.g., at POS devices 12, at a POS controller (not shown) coupled to POS devices 12, at acquirer 22, at issuer 20, etc.).

The table includes entries identifying individual transactions completed by consumers using qualifying accounts in promotional programs pursuant to embodiments of the present invention. Those skilled in the art will recognize that the database 400 is simplified for the purpose of explaining features of the present invention. In use, database 400 may contain huge amounts of transaction data, including transaction data from consumers having accounts that are not participating in promotions pursuant to embodiments of the present invention. Search techniques or programs may be used to specifically identify those consumers who are participating in promotions (e.g., by identifying participating accounts from promotion database 300 of FIG. 5).

The table also defines fields 402-408 for each of the entries. In one embodiment, the fields specify: an account identifier 402, a date 404, an amount 306, and purchase details 408. The information in transaction database 400 may be created and updated, based on transaction information received from, for example, POS devices 12. The capture, collection, and storage of account and transaction information is well-known in the art and will not be further detailed herein.

Account identifier 402 is information received from a transaction conducted by a consumer using a transaction card such as a credit card. This information may be captured from a magnetic stripe, smart card, or other means known in the art.

Date 404 includes information identifying the date on which a purchase has been made using the consumer's account identified by account identifier 402. This date information may be identified and recorded or stored by a transaction device, such as POS device 12. Other information may also be included, such as a time of the transaction.

Amount 406 includes information identifying an amount of the purchase made by the consumer having an account identified by account identifier 402 on the date identified by date 404. This information may be captured, recorded, and stored by a transaction device, such as POS device 12. Other information may be included, such as a currency of the purchase, or the like.

Purchase details 408 may include information further identifying the particular purchase made by the consumer using the account identified by account identifier 402 such as, for example: information identifying the merchant, merchant location, information identifying the item(s) purchased, etc.

Those skilled in the art will recognize that other information may also be provided in transaction database 400, such as, for example, information specifying a transaction identifier, information identifying the approval status of the transaction, etc. In some embodiments, consumers may make multiple qualifying purchases in a single day. The information may be stored in transaction database 400, and information may be provided indicating whether each of the transactions is promotion-eligible. For example, in some embodiments, all purchases made on a single day will be considered promotion-eligible (even if one of the two purchases was the triggering purchase). In some embodiments, only the purchases made after the initial triggering purchase will be considered promotion-eligible. In some embodiments, transaction database 400 may include a promotion code that is appended to each eligible transaction (e.g., this may be performed in a batch process on a regular basis). The promotion code may be appended to each transaction based on individual program rules to identify qualifying transactions.

Although the present invention has been described with respect to a preferred embodiment thereof, those skilled in the art will note that various substitutions may be made to those embodiments described herein without departing from the spirit and scope of the present invention. For example, while a separate promotion processor 16 was described, those skilled in the art will recognize that the functionality of the promotion processor may be contained within existing systems operated by entities such as merchants, merchant processors, acquirers, acquirer processors, issuers, issuer processors, or the like. While an embodiment having particular promotion benefits (including a no-payment and/or no-interest period) has been described, those skilled in the art will recognize that other promotion benefits may also be offered and managed using techniques of embodiments of the present invention.

As another example, while magnetic card processing techniques have been described, features of embodiments may also be implemented using “smart cards” or cards having electronic memory (and, in some cases, processing capability). Voucher information (e.g., such as voucher identifiers) may be downloaded to participating smart cards and used to identify promotions operated pursuant to embodiments of the present invention.

FIGS. 1, 2, 3, 4, and 5 are block diagrams, flowcharts and control flow illustrations of methods, systems and program products according to embodiments of the invention. It will be understood that each block or step of the block diagrams, flowcharts and control flow illustrations, and combinations of blocks in the block diagrams, flowcharts and control flow illustrations, can be implemented by computer program instructions. These computer program instructions may be loaded onto a computer or other programmable apparatus to produce a machine, such that the instructions which execute on the computer or other programmable apparatus create means or devices for implementing the functions specified in the block diagrams, flowcharts or control flow block(s) or step(s). These computer program instructions may also be stored in a computer-readable memory that can direct a computer or other programmable apparatus to function in a particular manner, such that the instructions stored in the computer-readable memory produce an article of manufacture, including instruction means or devices which implement the functions specified in the block diagrams, flowcharts or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagrams, flowcharts or control flow block(s) or step(s).

Accordingly, blocks or steps of the block diagrams, flowcharts or control flow illustrations support combinations of means or devices for performing the specified functions, combinations of steps for performing the specified functions and program instruction means or devices for performing the specified functions. It will also be understood that each block or step of the block diagrams, flowcharts or control flow illustrations, and combinations of blocks or steps in the block diagrams, flowcharts or control flow illustrations, can be implemented by special purpose hardware-based computer systems which perform the specified functions or steps, or combinations of special purpose hardware and computer instructions.

What is claimed is:

1. A method for operating a credit promotion program, comprising:
identifying a consumer;
identifying a voucher associated with the credit promotion program;
identifying a purchase by the consumer, including a purchase amount and a purchase date;
opening a credit promotion period for the consumer if the purchase amount exceeds a pre-established trigger amount; and
providing the consumer with predetermined benefits applicable to purchases made by the consumer during the promotion period.

2. The method of claim 1, further comprising:
monitoring purchases during the credit promotion period.

3. The method of claim 1, further comprising:
ending the credit promotion period a predetermined time from the purchase date;
calculating a total amount of qualifying purchases made by the cardholder during the credit promotion period; and
providing the consumer with a credit benefit based on the total amount.

4. The method of claim 1, wherein said identifying a consumer further comprises:
identifying a credit account associated with the consumer.

5. The method of claim 4, wherein said identifying a credit account further comprises:
reading card data at a point of sale device.

6. The method of claim 1, wherein said identifying a voucher further comprises:
scanning a bar code on the voucher to detect a voucher identifier; and
comparing the voucher identifier with a plurality of stored voucher identifiers.

7. The method of claim 6, further comprising:
determining if the voucher is valid.

8. The method of claim 4, further comprising:
determining if the consumer is eligible for the credit promotion program.

9. The method of claim 1, comprising:
establishing a credit account for the consumer.

10. The method of claim 1, comprising a medium storing processor-executable code to perform each of said identifying and opening steps.

11. A method for operating a credit promotion program, comprising:
identifying a consumer;
establishing terms of the credit promotion program, the terms including at least a promotion duration and a promotion trigger amount;
receiving input from the consumer indicating a desired start date of the promotion;
starting the promotion on the desired start date; and
providing a promotion benefit to the consumer applicable to purchases by the consumer during the promotion duration.

12. A method for operating a credit promotion program, comprising:
identifying a consumer;
establishing terms of the credit promotion program, the terms including at least a promotion duration and a promotion trigger amount;
establishing a credit account for the consumer;
identifying a qualifying purchase by the consumer using the credit account, the qualifying purchase starting a promotion period for the consumer; and
providing a promotion benefit to the consumer applicable to purchases by the consumer during the promotion period.

13. A method for establishing a credit promotion program, comprising:
establishing terms of the credit promotion program, including at least a trigger event and a promotional period duration;
identifying target consumers;
generating a plurality of vouchers for initiating the credit promotion program, and forwarding the plurality of vouchers to the target consumers;
identifying the occurrence of the trigger event for at least one of the target consumers;
starting a promotion period for the at least one target consumer; and
providing a promotion benefit to the at least one target consumer applicable to purchases by the consumer during the promotion period.

14. The method of claim 13, further comprising a medium storing processor-executable code to perform each of said establishing, identifying, generating and monitoring steps.

15. A system for establishing a credit promotion program, comprising:
means for establishing terms of said credit promotion program, including at least a trigger event and a promotional period duration;
means for identifying target consumers;
means for generating a plurality of vouchers for initiating said credit promotion program, and forwarding said plurality of vouchers to said target consumers;
means for identifying the occurrence of said trigger event for at least one of said target consumers;
means for starting said promotional period duration for said at least one target consumer; and
means for providing a promotion benefit to said at least one target consumer applicable to purchases by said at least one target consumer during said promotional period duration.

16. An apparatus for establishing a credit promotion program, comprising:
a processor;
a communications device in communication with said processor to receive data identifying terms of the credit promotion program, including at least a trigger event and a promotional period duration; and
a memory unit in communication with said processor and storing a program, wherein the processor is operative with said program to
identify target consumers;
initiate the generation of a plurality of vouchers for initiating the credit promotion program;
cause said plurality of vouchers to be forwarded to said target consumers; and
identify the occurrence of said trigger event for at least one of said target consumers;
start said promotional period duration for said at least one target consumer; and
provide a promotion benefit to said at least one target consumer applicable to purchases by said at least one target consumer during said promotional period duration.

17. A system for operating a credit promotion program, comprising:
means for identifying a consumer;
means for identifying a voucher associated with the credit promotion program;
means for identifying a purchase by said consumer, including a purchase amount and a purchase date;
means for opening a credit promotion period for said consumer if said purchase amount exceeds a pre-established trigger amount
means for providing a promotion benefit to said consumer applicable to purchases by said consumer during said credit promotion period.

18. An apparatus for operating a credit promotion program, comprising:
a processor;
a communications device in communication with said processor, said communication device receiving data identifying a consumer and data identifying an amount of a purchase by said consumer; and
a memory unit in communication with said processor and storing a program, wherein the processor is operative with said program to
identify a voucher associated with the credit promotion program;
open a credit promotion period for said consumer if the amount of said purchase exceeds a pre-established trigger amount and wherein said consumer is entitled to promotion benefits for purchases by said consumer during said credit promotion period.
